(19) United States
(12) Patent Application Publication
(10) Pub. No.: US 2010/0005414 A1
(43) Pub. Date: Jan. 7, 2010

(54) DISPLAY METHOD AND DISPLAY DEVICE

(75) Inventors: Mikine ISHIGURO, Yokohama (JP); Shigeru Hirahata, Oiso (JP); Hiroyuki Koreeda, Fujisawa (JP); Masaru Nanki, Yokohama (JP)

Correspondence Address: MCDERMOTT WILL & EMERY LLP, 600 13TH STREET, N.W., WASHINGTON, DC, 20005-3096, US

(73) Assignee: HITACHI,LTD, Tokyo (JP)

(21) Appl. No.: 12/562,453

(22) Filed: Sep. 18, 2009

Related U.S. Application Data
(63) Continuation of application No. 11/063,723, filed on Feb. 24, 2005.

(30) Foreign Application Priority Data
Feb. 27, 2004 (JP) 2004-052701

(51) Int. Cl. G06F 3/048

(52) U.S. Cl. 715/802; 715/862

(57) ABSTRACT

The composition mentioned hereinafter has been chosen to enable switching over the window targeted for manipulation by manipulating an arrow key, in case a subwindow which can be manipulated with a free cursor is present inside a main window which can be manipulated with a block cursor. In a state in which subwindow is focused during manipulation of main window, there is a switchover, by detection of lapse of a fixed time T, to manipulation of subwindow. In addition, in a state in which the free cursor is present in a border portion of subwindow during manipulation of subwindow, there is a switchover to main window as a result of detection of any one of: manipulation of key in the subwindow outward direction, pressing of key for a fixed time in the subwindow outward direction, and lapse of a fixed time T.

### INCORPORATION BY REFERENCE

The present application claims priority from Japanese application JP 2004-052701 filed on Feb. 27, 2004, the content of which is hereby incorporated by reference into this application.

### BACKGROUND OF THE INVENTION

The present invention pertains to a display method and a display device concerned with manipulability on a user display screen.

To select, by key manipulation, objects like buttons, character strings, and icons (below, these are by generic naming called ‘objects’) for manipulating application software provided in a window, there are, broadly speaking, two types of selection methods, the block cursor method and the free cursor method.

In recent years, due to the multimedia support of personal computers, one major current is for personal computers to have a television receiver function, and it is becoming another major current that television receivers also, through the process of transition towards digital broadcasting, have functionality supporting the Internet. However, since these two devices have developed for industrial use and for entertainment use accompanying the merging of personal computers and television receivers, the two aforementioned manipulation methods coexist, e.g. in television receivers with Internet support.

There have been disclosures regarding the control of display manipulation in the case of the coexistence of the two aforementioned manipulation methods, e.g. in the JP-A-2000-89892 publication (Patent Document 1).

### SUMMARY OF THE INVENTION

The block cursor method is a method in which, when selecting one of multiple objects provided in a window, e.g. with the GUI (Graphical User Interface) display control method represented by the manipulation of the remote control of a television receiver, e.g. by means of manipulation of the up arrow key, the down arrow key, the left arrow key, and the right arrow key (below, these are by generic naming called ‘arrow keys’), a block cursor, e.g. block-shaped, moves between objects in e.g. the four pre-determined directions up, down, left, and right. In this block cursor method, the object targeted for selection in the window is highlighted (below, this highlighting is mentioned as ‘focus’) with the block cursor indicated by the area displayed, e.g. with a border in bold surrounding that area or by a change of color (normally called ‘highlighting’). Then, by means of a selection operation, e.g. the manipulation of a decision key, the selection of the object targeted for selection is decided, and the operation related with the object is executed.

The free cursor method is a method in which a cursor, e.g. with the GUI display control method represented by the manipulation of the mouse of a personal computer, moves continuously in an arbitrary direction in the window. In this sense, the cursor is normally called a free cursor. In this free cursor method, the free cursor (below mentioned as ‘pointer’) is displayed in the window. The pointer moves by means of manipulation of the mouse, and since, if the pointer moves to an area where there is an object, the shape of the latter changes, the selection of the object corresponding to the coordinates of the pointer is decided, e.g. by means of a selection operation with a manipulation of the decision key, and the operation related with the concerned object is executed.

As mentioned above, as far as e.g. television receivers with Internet support are concerned, the two aforementioned manipulation methods coexist. It is for this reason that, conventionally, if a subwindow where manipulations with a free cursor are possible was present, inside the main window where manipulations with a block cursor are possible, control of the switchover of the active window between the main window and the subwindow became necessary, since the manipulation schemes were different, in areas having different manipulation schemes, as has e.g. been disclosed in Patent Document 1. Accompanying this control of the switchover of the active window, the following inconvenience arises.

As shown in FIG. 8, in case there are focusable character string objects 130, 160 and a subwindow 120 in a main window 110, one considers moving the object targeted for selection with the not illustrated arrow key from object 130 to object 160. Now, when object 130 is focused and targeted for selection by a focus 140 (i.e. when the position of the block cursor is in object 130), if the focus position is moved by manipulation of the arrow key in the downward direction in the diagram space, the free cursor, e.g. an arrow pointer (not illustrated), is displayed at the upper border portion of subwindow 120, and subwindow 120 becomes the active window. If the pointer is made, with the arrow key, to move within the area of subwindow 120 towards the lower border and cross it, the cursor is switched from a pointer into a block cursor, main window 110 becomes the active window, the cursor moves from subwindow 120 to object 160, which is to say that object 160 is focused, and object 160 becomes the object targeted for selection.

In this way, as regards the art of the aforementioned Patent Document 1, if the object targeted for selection is moved from object 130 to object 160 and there is a subwindow along the path of movement of the block cursor, the subwindow is temporarily made active, switching the cursor into a pointer constituting a free cursor, making it necessary to move the pointer within the area of this subwindow to a border position in the desired direction and make it cross the border, something that takes time.

In addition, the following control technique, which differs from the art of the aforementioned Patent Document 1, is also applied at present.

Specifically, the switchover of the active window from the main window to the subwindow is performed by focusing the subwindow, while the main window is manipulated, by means of a selection operation, e.g. by a manipulation of the decision key with the subwindow in a focused state, making the subwindow active. Then, after this manipulation of the decision key, the pointer constituting a free cursor is displayed.

Also, the switchover of the active window from the subwindow to the main window is performed by means of a selection release operation, e.g. by a manipulation of the return key while the subwindow is manipulated, making the main window active.

To explain it with FIG. 8, in the present example differing from the aforementioned Patent Document 1, it is possible, since subwindow 120 does not become active by the movement of the focus, to smoothly change the selection target from object 130 to subwindow 120 to object 160 by manipulation of the arrow key.

For the switchovers of the active window between the main window and the subwindow, however, it is necessary to manipulate a key separate from the arrow keys for moving the focus or the pointer, something which is hard to understand for the user and has the inconvenience of making manipulation complicated for the user.

A disclosure is briefly given regarding the provision, with the present invention which has been created in taking the aforementioned circumstances into consideration, of a display control method and a display device that can perform the switchover of the active window between a main window and a subwindow having different manipulation schemes, without complicated manipulation.

In order to attain the aforementioned objective, the display control method of the present invention is characterized by switching over to subwindow manipulation as a result of detecting the lapse of a fixed time, e.g. in a state in which the subwindow is focused during manipulation of the main window. Also, it is characterized by switching over to main window manipulation as a result of detecting, in a state in which the pointer is in the border portion of the subwindow during manipulation of the subwindow, any one of: the manipulation of a key in the subwindow outward direction, the holding down of the key for a fixed time in the subwindow outward direction, and the lapse of a fixed time.

In addition, in order to attain the aforementioned objective, the display control device of the present invention is characterized in that it is provided with a time detection means detecting, during manipulation of a block cursor in the main window, that a predetermined time has elapsed in a state with the subwindow being focused, and that it has a first display control means switching over, in response to the output of the time detection means, from block cursor display manipulation in the main window to free cursor display manipulation in the subwindow. Also, it is characterized in that it is provided with a border detection means, detecting a state in which the free cursor is in the border portion of the subwindow, and a time detection means detecting that a predetermined time has elapsed, and that it has a second display control means which, in response to the output of the border detection means and the output of the time detection means, switches over from free cursor display manipulation in the subwindow to block cursor display manipulation in the main window.

Since the user is able to perform the switchover of the active window between the main window and the subwindow by manipulating only the arrow keys, complicated switchover manipulations become unnecessary and the need to be aware of the active window also disappears.

According to the present invention, it is e.g. possible to provide display methods which are easy to use from the viewpoint of the users.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B represent the first embodiment of the display control method, showing the switchover of the active window from a main window to a subwindow according to the present invention.

FIG. 2 is a flowchart showing the display control process, in an embodiment of the present invention, detecting the lapse of a fixed time in a state in which the subwindow is focused and making subwindow manipulation active.

FIGS. 3A and 3B are examples of the display control method showing the switchover of the active window from the subwindow to the main window according to the present invention.

FIG. 4 is a flowchart showing the display control process which, in an embodiment of the present invention, detects the manipulation of a key in the subwindow outward direction, in a state in which the pointer is in the border portion of the subwindow, and makes main window manipulation active.

FIG. 5 is a flowchart showing the second embodiment.

FIG. 6 is a flowchart showing the third embodiment.

FIG. 7 is a block diagram of the display device having a GUI processing function according to the present invention.

FIG. 8 is an explanatory diagram of prior art.

### DETAILED DESCRIPTION OF THE EMBODIMENT

Hereinafter, the implementation modes of the present invention will be described with reference to the drawings. Further, in each figure, elements having common functions are shown with like reference numerals attached, and regarding matters which have once been explained, reiteration of the explanation is omitted in order to avoid complication.

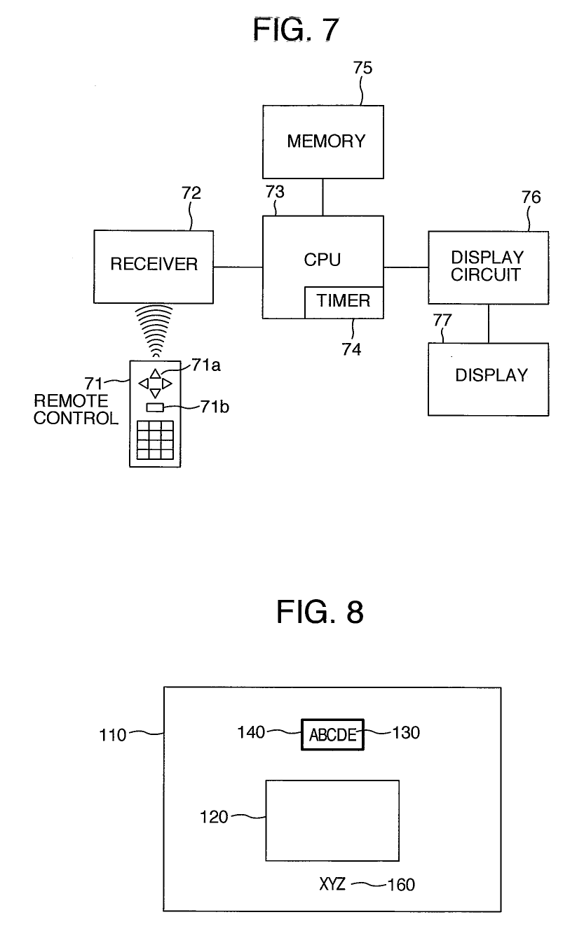

FIG. 7 is a block diagram of a display device having a GUI processing function showing an implementation mode according to the present invention.

In FIG. 7, 71 is a remote control unit (hereinafter abbreviated as ‘remote control’) transmitting, e.g. with infrared radiation, remote controller signals (hereinafter abbreviated as ‘remote control signals’) corresponding to the manipulation of arrow keys 71a (consisting of an up arrow key, a down arrow key, a right arrow key, and a left arrow key) moving e.g. a cursor, and a decision key 71b etc., 72 is a receiver receiving the remote control signals and converting these to electric signals, 73 is a central processing unit (hereinafter mentioned as ‘CPU’) performing the control of the whole display device, and 75 is a memory composed of e.g. a flash memory storing programs executed by CPU 73 and information resulting from execution of the programs. In memory 75, there is stored, in addition to programs, e.g. object information, application software programs respectively related with the objects, position information resulting from the display of object information in windows of the display screen (object size, coordinates), main window size and coordinates, subwindow size and coordinates, focus information of the active window and the main window, and subwindow pointer coordinates, etc. 77 is a display, and 76 is a display circuit having a GUI processing function, which, together with displaying TV images on display 77, displays object information in the window of the display screen of display 77, on the basis of various kinds of information stored in memory 75, such as object information and object position information, and controlled by CPU 73. Further, 74 is a timer (time detection means) measuring time and built into CPU 73. Here, timer 74 is assumed to be built into the CPU, but it is not limited to this and may also be external.

In the following, a description of the operation in FIG. 7 will be given. The remote control signal transmitted from remote control 71 is received and decoded by receiver 72 and communicated to CPU 73. CPU 73, based on information from remote control 71 and in accordance with the programs stored in memory 75, performs display control of graphic images (e.g. objects, focus, pointer, etc.) displayed on the display screen of display 77 through the GUI processing function of display circuit 76 and display control of the subsequently described switchovers of the active window performed between the main window and the subwindow.

E.g., if there is a manipulation of arrow key 71a of remote control 71, CPU 73, responding to the direction of the manipulated arrow key 71a, updates the focus position of the main window and the coordinates of the pointer of the subwindow and moves the cursor (i.e. the focus or the pointer), and if there is an object at the position of the cursor, it performs the process of the operation related with the object by manipulation of the decision key. In addition, accompanying the movement of the cursor, control of the subsequently described switchover of the active window between the main window and the subwindow is performed.

Hereinafter, a description will be given of an embodiment of the GUI display control method occurring at the time of processing the switchovers of the active window between the main window and the subwindow in the display screen displayed on display 77, using the GUI processing function of display circuit 76.

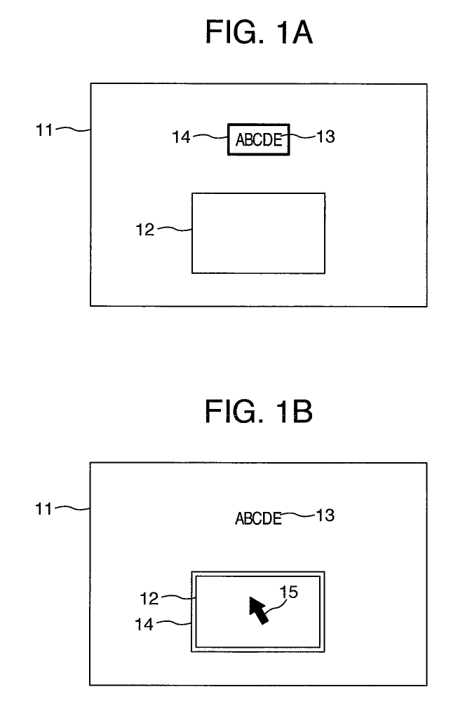

FIGS. 1A and 1B represent the first embodiment of the display control method, showing the switchover of the active window from a main window to a subwindow, according to the present invention.

In FIGS. 1A and 1B, 11 is a main window, 12 is a subwindow, 13 is a character string indicating an object, 14 is a focus, and 15 is a pointer.

Here, subwindow 12 and character string 13 are focusable objects in the main window and, in response to a movement of the focus by a manipulation of arrow key 71a, indicate a focused object, by focus 14. Also, pointer 15 is displayed after the active window has switched over to the subwindow and moves inside the subwindow through key manipulation.

First, as shown in FIG. 1A, main window 11 is an active window in which e.g. cursor movement manipulation etc. is possible, and character string 13 is focused.

At this time, by pressing the down arrow key from among arrow keys 71a, as shown in FIG. 1B, focus 14 moves to subwindow 12. If some time elapses in this state, pointer 15 is displayed and the active window switches over from main window 11 to subwindow 12. From this point on, it becomes possible to move pointer 15 with arrow key 71a inside subwindow 12.

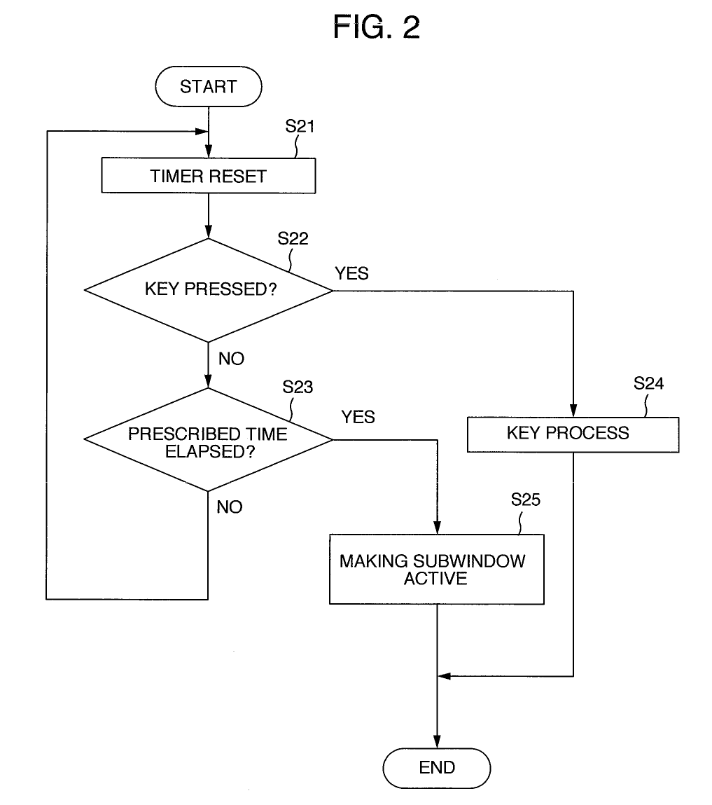

FIG. 2 is a flowchart showing the display control process, in the present embodiment, detecting the lapse of a fixed time in a state in which the subwindow is focused and making subwindow manipulation active.

In FIG. 2, when the process is started, CPU 73 first initializes timer 74 to 0 (reset) in Step S21. Subsequently, in Step S22, it checks whether a key is pressed, and if the pressing of a key has been detected, it performs the process corresponding to the pressed key in Step S24, and terminates the process. In this case, the main window remains the active window. If no pressing of a key has been detected in Step S22, it checks the lapse time of timer 74 in Step S23 to find out whether the prescribed fixed time T1 has elapsed. In case the prescribed time T1 has elapsed in Step 23, it makes the subwindow active in Step 25 and ends the process.

In the present embodiment, if character string 13 is positioned above subwindow 12, the focus is moved by manipulation of the down arrow key, but another combination of position relationship and manipulation key is also acceptable, e.g. like pressing the right arrow key in a state in which character string 13 is to the left of subwindow 12. Also, character string 13 is one example of a focusable object in the main window, but other objects like images are also acceptable.

In addition, if subwindow 12 becomes active, pointer 15 is displayed, but since there is a possibility that the subsequently described switchover, according to the present invention, of the active window from the main window to the subwindow is performed, if the displayed position of pointer 15 at this time is in the border portion of subwindow 12, it is preferable for the initial position of pointer 15 to be displayed in a subwindow 12 portion other than the border portion, such as the center, as shown in FIG. 1B.

Subsequently, an explanation will be given of the display control process in the case of a switchover of the active window from the subwindow to the main window.

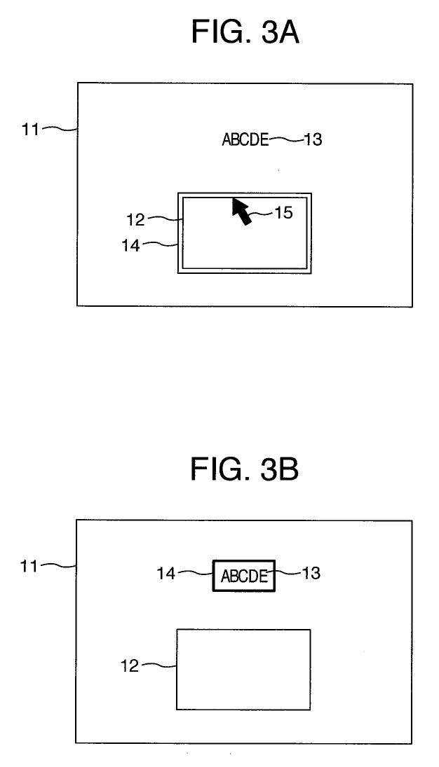

FIGS. 3A and 3B are examples of the display control method showing the switchover of the active window from the subwindow to the main window according to the present invention.

First, as shown in FIG. 3A, subwindow 12 is the active window and pointer 15 is positioned at the upper border of subwindow 12. In this case, the key for the outward direction of the subwindow is the up arrow key. In this state, in case the pressing of the up arrow key is detected, as shown in FIG. 3B, focus 14 of main window 11 focuses on character string 13 and the active window is switched over from subwindow 12 to main window 11.

Further, in the present embodiment, CPU 73 detects the border at which pointer 15 is positioned, as mentioned hereinafter.

In a state in which subwindow 12 is the active window, CPU 73 holds the subwindow size and coordinates and the coordinates of subwindow pointer 15 in memory 75. In case an arbitrary coordinate of the border portion of the subwindow, which can be obtained from the size and the coordinates of the subwindow, coincides with the coordinate of the pointer, CPU 73 judges that pointer 15 is in a border portion of subwindow 12.

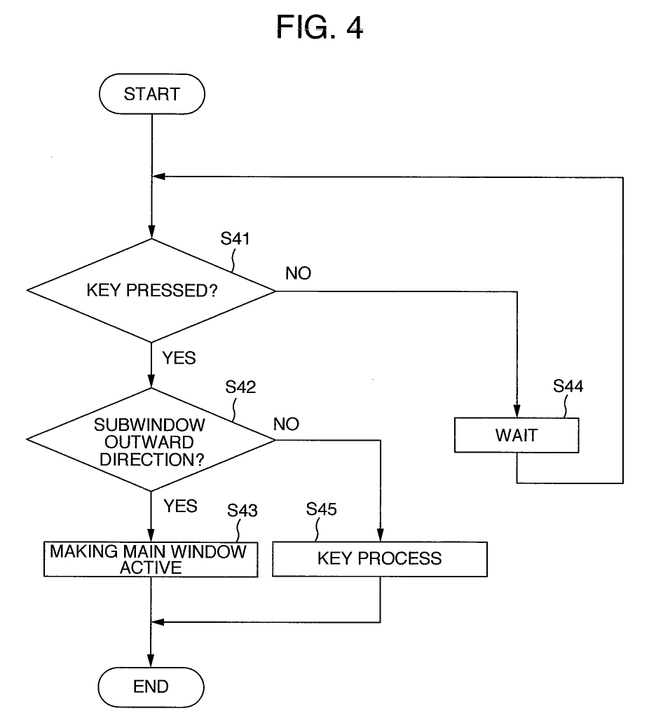

FIG. 4 is a flowchart showing the display control process which, in the aforementioned embodiment, detects the manipulation of a key in the subwindow outward direction, in a state in which the pointer is in the border portion of the subwindow, and makes manipulation of the main window active.

In FIG. 4, when the process is started, in case there is no detection of the pressing of a key in Step S41, Step S44 introduces a wait and returns to Step S41. In case the pressing of a key has been detected in Step S41, it is determined in Step S42 whether the pressed key is a key in the subwindow outward direction. If the key of Step S42 is not a key in the subwindow outward direction, the process corresponding to the pressed key is performed in Step S45, and the process is ended. In this case, the subwindow remains the active window. In case the key pressed in Step S42 is a key in the subwindow outward direction, the main window is made active in Step S43, the object (in the present example, character string 13) in main window 11 which is adjacent to subwindow 12 in the direction of the pressed outward direction arrow key is focused, and the process is ended.

As described above, since it is possible, according to the present invention, for the user to perform the switchover of the active window between the main window and the subwindow by only manipulating the arrow keys, complex switchover manipulations become unnecessary, and the need to be aware of the active window also disappears.

In the first embodiment, the condition for switching over the active window from the subwindow to the main window was assumed to be, in the state in which pointer 15 was positioned at the border of subwindow 12, the time that a manipulation of the arrow key was performed in the outward direction of subwindow 12, but a description will hereinafter be given of a second embodiment in which a switchover is carried out by pressing the arrow key in the subwindow 12 outward direction for a prescribed time (so-called ‘holding down’).

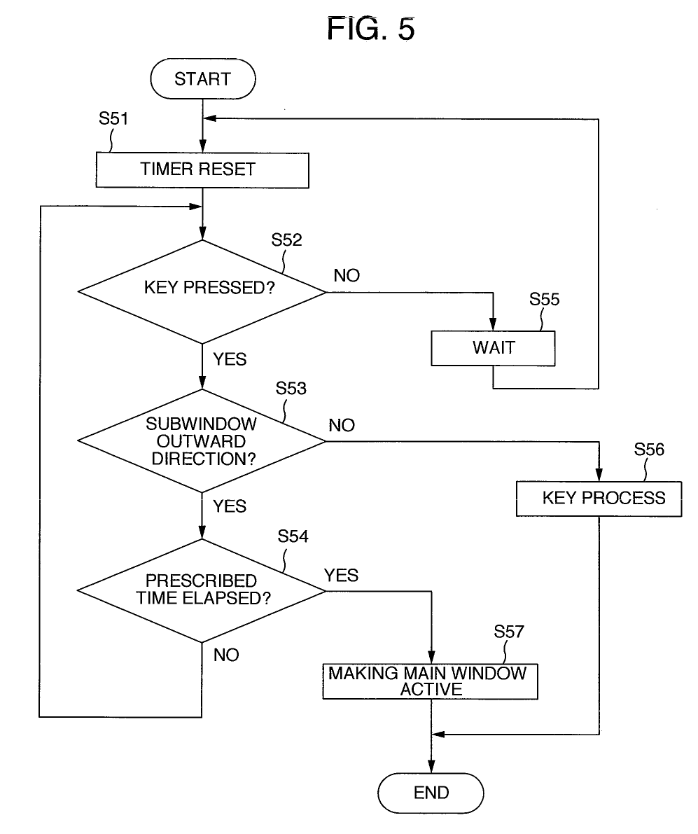

FIG. 5 is a flowchart showing the second embodiment and shows the display control process in which manipulation in the main window is made active when the pressing of a key in the subwindow outward direction for a fixed time is detected, in a state in which the pointer is in the border portion of the subwindow.

In FIG. 5, when the process is started, CPU 73 first initializes timer 74 to 0 (reset) in Step S51. Subsequently, it checks whether a key is pressed in Step S52, and in case there is no detection of the pressing of a key, it introduces a wait in Step S55, and returns to Step S51. In case the pressing of a key is detected in Step S52, it determines in Step S53 whether the pressed key is a key in the subwindow outward direction. In case it was not a key in the subwindow outward direction in Step S53, it performs the process corresponding to the pressed key in Step S56, and ends the process. In this case, the subwindow remains the active window. In case the key in Step S53 was a key in the subwindow outward direction, it checks the lapse time of timer 74 in Step S54 to find out whether the prescribed fixed time T2 has elapsed. In case the prescribed time T2 has not elapsed in Step S54, it returns to Step S52. In case the prescribed time T2 has elapsed in Step S54, it makes the main window active in Step S57, focuses the object (in this example, character string 13) in main window 11 which is adjacent to subwindow 12 in the direction of the pressed outward direction arrow key, and ends the process.

Subsequently, an explanation will be given of a third embodiment switching over the active window from the subwindow to the main window.

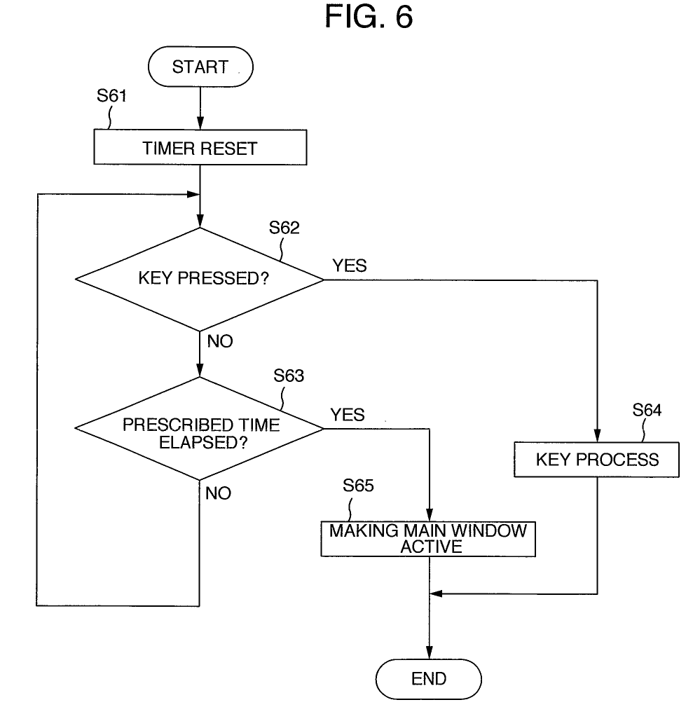

FIG. 6 is a flowchart showing the third embodiment and shows the display control process in which manipulation in the main window is made active when the lapse of a fixed time is detected, in a state in which the pointer is in the border portion of the subwindow.

In FIG. 6, when the process is started, CPU 73 first initializes timer 74 to 0 (reset) in Step S61. Subsequently, in Step S62, it checks whether a key is pressed and, in case the pressing of a key has been detected, it performs the process corresponding to the pressed key in Step S64, and ends the process. In this case, the subwindow remains the active window. In case there has been no detection of the pressing of a key in Step S62, it checks the lapse time of timer 74 in Step S63 to find out whether fixed time T3 has elapsed. In case the prescribed time T3 has not elapsed in Step S63, it returns to Step S62. In case the fixed time T3 has elapsed in Step S63, it makes the main window active in Step S65, focuses the object (in this example, character string 13) in main window 11 which is adjacent to the border where pointer 15 is, and ends the process.

In the present embodiment, character string 13 is positioned above subwindow 12 and pointer 15 is positioned at the upper border of subwindow 12, but another combination of position relationships is also acceptable, e.g. in a state in which character string 13 is to the left of subwindow 12 and pointer 15 is at the left-hand border of subwindow 12. Also, character string 13 is one example of a focusable object in the main window, but other objects like images are also acceptable.

It should be further understood by those skilled in the art that although the foregoing description has been made on embodiments of the invention, the invention is not limited thereto and various changes and modifications may be made without departing from the spirit of the invention and the scope of the appended claims.

1-7. (canceled)

8. A display method for displaying a main window operable by a block cursor movable according to a user's instruction, for focusing on one of a plurality of objects, and a sub-window operable by a free cursor continuously movable according to the user's instruction on a display unit by a control circuit, and displaying the sub-window together with the plurality of objects within the main window, the display method comprising the steps of:
moving, in a state where the main window is of an active window, the block cursor focusing on one of the plurality of objects to the sub-window according to the user's instruction, and focusing on the sub-window by the block cursor, by the control circuit;
detecting the elapse of a given period of time by the control circuit in a state where the sub-window is focused by the block cursor; and
migrating the active window from the main window to the sub-window focused by the block cursor by the control circuit when the elapse of the given period of time is detected, and displaying the free cursor in the sub-window.

9. The display method according to claim 8,
wherein when the user's instruction allows the free cursor to go in an outward direction of the sub-window in a state where the sub-window is of the active window, and the free cursor is located on a boundary portion of the sub-window,
the active window is migrated from the sub-widow to the main window by the control circuit, and the object within the main window which is close to the sub-window in the outward direction is focused by the block cursor.

10. The display method according to claim 8,
wherein when the user's instruction for allowing the free cursor to go in an outward direction of the sub-window is conducted for a given period of time in a state where the sub-window is of the active window, and the free cursor is located on a boundary portion of the sub-window,
the active window is migrated from the sub-widow to the main window by the control circuit, and the object within the main window which is close to the boundary portion at which the free cursor is located is focused by the block cursor.

11. The display method according to claim 8,
wherein when a period of time during which the user's instruction is not conducted is elapsed for a given period of time in a state where the sub-window is of the active window, and the free cursor is located on a boundary portion of the sub-window,
the active window is migrated from the sub-widow to the main window by the control circuit, and the object within the main window which is close to the boundary portion at which the free cursor is located is focused by the block cursor.

12. A display device having a control circuit for displaying a main window operable by a block cursor movable according to a user's instruction, for focusing on one of a plurality of objects, and a sub-window operable by a free cursor continuously movable according to the user's instruction on a display unit, and configured to display the sub-window together with the plurality of objects within the main window, the control circuit comprising:
a first unit which moves, in a state where the main window is of an active window, the block cursor focusing on one of the plurality of objects to the sub-window according to the user's instruction, and focusing on the sub-window by the block cursor;
a second unit which detects the elapse of a given period of time in a state where the sub-window is focused by the block cursor; and
a third unit which migrates the active window from the main window to the sub-window focused by the block cursor when the elapse of the given period of time is detected, and displaying the free cursor in the sub-window.

13. The display device according to claim 12,
wherein when the user's instruction allows the free cursor to go in an outward direction of the sub-window in a state where the sub-window is of the active window, and the free cursor is located on a boundary portion of the sub-window,
the control circuit migrates the active window from the sub-widow to the main window, and focuses the object within the main window which is close to the sub-window in the outward direction by the block cursor.

14. The display device according to claim 12,
wherein when the user's instruction for allowing the free cursor to go in an outward direction of the sub-window is conducted for a given period of time in a state where the sub-window is of the active window, and the free cursor is located on a boundary portion of the sub-window,
the control circuit migrates the active window from the sub-widow to the main window, and focuses the object within the main window which is close to the boundary portion at which the free cursor is located by the block cursor.

15. The display device according to claim 12,
wherein when a period of time during which the user's instruction is not conducted is elapsed for a given period of time in a state where the sub-window is of the active window, and the free cursor is located on a boundary portion of the sub-window,
the control circuit migrates the active window from the sub-widow to the main window, and focuses the object within the main window which is close to the boundary portion at which the free cursor is located by the block cursor.
